(19) United States
(12) Patent Application Publication
(10) Pub. No.: US 2014/0141330 A1
(43) Pub. Date: May 22, 2014

(54) METHOD OF PRODUCING SILICON-CONTAINING COMPOSITION, ANODE MATERIAL AND METHOD OF PRODUCING ANODE ELECTRODE OF LITHIUM-ION BATTERY

(71) Applicant: QUAN AN RESOURCE CO., LTD., Taoyuan County (TW)

(72) Inventors: Tung-Ko Cheng, New Taipei City (TW); Li-Yin Hsiao, Tainan City (TW)

(73) Assignee: QUAN AN RESOURCE CO., LTD., Taoyuan County (TW)

(21) Appl. No.: 13/833,191

(22) Filed: Mar. 15, 2013

(30) Foreign Application Priority Data
Nov. 16, 2012 (TW) 101142795

(51) Int. Cl. H01M 4/04; H01M 4/36; B28D 1/02

(52) U.S. Cl. CPC H01M 4/04; B28D 1/025; H01M 4/364
USPC 429/218.1; 241/15; 29/623.5

(57) ABSTRACT

Provided is a method of producing a silicon-containing composition in mass production, comprising steps of: slicing a silicon substrate with a free-abrasive wire to obtain a mixing slurry; separating the mixing slurry into a liquid mixture and a solid mixture; and sorting the solid mixture by particle size and removing the cutting wire granules from the solid mixture, so as to obtain the silicon-containing composition applicable for a lithium-ion battery. Furthermore, an anode material of a lithium-ion battery and a method of producing an anode electrode of a lithium-ion battery are provided. According to the method, a few abrasives of the wire sawing tool remain in the nano-scale or micro-scale silicon-containing composition, and thus the problems of extreme volumetric expansion under heat and high production cost are overcome. The produced silicon-containing composition is applicable for a lithium-ion battery.

### CROSS-REFERENCE TO RELATED APPLICATION

Pursuant to 35 U.S.C. §119(a), this application claims the benefit of the priority to Taiwan Patent Application No. 101142795, filed Nov. 16, 2012. The content of the prior application is incorporated herein by its entirety.

### BACKGROUND OF THE INVENTION

1. Field of the Invention

The present invention relates to a method of producing a silicon-containing composition and its application, more particularly to a method of slicing a silicon substrate with a wire sawing tool to produce the silicon-containing composition having a few abrasives. In addition, the present invention also relates to an anode material of a lithium-ion battery and a method of producing an anode electrode of a lithium-ion battery.

2. Description of the Prior Arts

With advantages such as low electrode potential, high efficiency, and long cycle life, lithium-ion batteries have been widely applied in high-tech products, including mobiles and notebook computers, and electric vehicles.

Conventional lithium-ion batteries generally comprise carbon-based materials as the anode material in view of safety requirement. Commonly used carbon-based materials include natural graphite, artificial graphite, and mesophase asphalts. However, the conventional lithium-ion batteries only have a theory capacity about 372 mAh/g, which is inadequate for applications on high-tech products or long-distance electric-vehicles of the up-to-date demand.

In order to meet the high capacity demands, use of silicon as a principal anode material is developed for enhancing theory capacity of a lithium-ion battery up to about 4400 mAh/g.

However, an anode material of a lithium-ion battery comprising silicon still has several problems. For example, silicon has smaller density if forming a lithium-silicon alloy with lithium ions, and therefore it usually expands to almost 300% to 400% of its original volume during charge and discharge processes. As a result, such extreme but unavoidable volumetric expansion destroys the anode electrode and shortens the cycle life of the lithium-ion battery. Moreover, a lithium-ion battery with high capacity further produces abundant heat while charging and discharging, and thus can hardly provide desired cycle stability, electrical performance and quality.

To overcome the aforementioned problems and to produce a lithium-ion battery with desired capacity and cycle life, a silicon material with fine particles is used to avoid the volumetric expansion and anode break. In addition, inactive materials are also doped into the silicon material to supply thermal conductivity, and thereby providing the lithium-ion battery with improved cycle stability, electrical performance, and quality.

However, conventional methods, including chemical vapor deposition for making a silicon film, high energy ball milling or chemical synthesis for making silicon nanoparticles are too expensive for mass production, such that silicon materials still cannot replace conventional carbon-based materials and cannot be widely used for producing an anode material of a lithium-ion battery.

Based on the aforementioned problems, a method of producing a silicon-containing composition capable for mass production is much desired to improve its application for making a lithium-ion battery.

### SUMMARY OF THE INVENTION

In view of high costs and low quality with chemical vapor deposition, high energy ball milling and chemical synthesis, the first objective of the present invention is to provide a method of producing a large amount of fine silicon-containing compositions with inactive components, and thereby the produced silicon-containing composition is particularly applicable for an anode electrode of a lithium-ion battery.

To achieve the objective, the present invention provides a method of producing a silicon-containing composition, comprising the steps of:

providing a wire sawing tool comprising a cutting wire and a cutting slurry applied to the cutting wire, wherein the cutting slurry contains a carrier fluid and multiple abrasives dispersed in the carrier fluid and having particle sizes ranging from 1 micrometer to 50 micrometers;

slicing a silicon substrate with the wire sawing tool to obtain a mixing slurry;

separating the mixing slurry into a liquid mixture and a solid mixture by solid-liquid separation, wherein the solid mixture comprises silicon granules, abrasive granules, and cutting wire granules; and

sorting the solid mixture by particle size and removing the cutting wire granules from the solid mixture, so as to obtain the silicon-containing composition.

According to the method of the present invention, a large amount of silicon granules within a predetermined particle size range are produced by slicing the silicon substrate with the wire sawing tool. After several required purifications, a produced silicon-containing composition mainly comprises silicon and is mixed with a few abrasive granules, and thus is favorable for an anode material of a lithium-ion battery. Accordingly, a simplified method for mass production of silicon-containing composition is provided, which significantly reduces the production cost and process complexity of an anode of the lithium-ion battery.

In accordance with the present invention, the wire sawing tool is directed to a tool with a free-abrasive wire.

In accordance with the present invention, a cutting slurry is sprayed onto the cutting wire to surround the cutting wire homogeneously. When the cutting wire is operated by driving rollers to slice the silicon substrate, the cutting slurry is moved with the rapidly-moved cutting wire. The abrasives contained in the cutting slurry contact both an edge of the cutting wire and the surface of the silicon substrate, are thereby disposed between the cutting wire and the silicon substrate for grinding the silicon substrate to obtain a large amount of silicon granules during slicing.

In accordance with the present invention, said “mixing slurry” is collected from the step of slicing the silicon substrate with the wire sawing tool, which comprises silicon granules from the silicon substrate, cutting wire granules from the cutting wire of the wire sawing tool, abrasive granules from the abrasives of the wire sawing tool, and remainder from the carrier fluid or their combinations.

In accordance with the present invention, a material of either the cutting wire or the cutting wire granules is iron, copper, nickel, their alloy or their combinations.

In accordance with the present invention, a material of either the abrasives or the abrasive granules is selected from the group consisting of: diamond, diamond-like carbon, silicon carbide, boron carbide, boron nitride, aluminum nitride, zirconium dioxide and their combinations. Said abrasives are favorable as inactive components of an anode material in a lithium-ion battery to provide the silicon-containing composition with thermal conductivity.

Preferably, abrasive granules favorable as inactive components are, for example, silicon carbide, diamond or boron nitride, such that the mixing slurry may comprise silicon and abrasives or their crumbs. Consequently, a silicon-containing composition mixed with abrasive granules is more effective on improving a lithium-ion battery with heat dissipation.

In accordance with the present invention, the carrier fluid of the cutting slurry is a carrier fluid with desired viscosity, including a non-aqueous carrier fluid, an aqueous carrier fluid or a synthetic carrier fluid. Preferably, the non-aqueous carrier fluid mainly comprises mineral oil. Preferably, the aqueous carrier fluid comprises mineral oil, an emulsifying agent, a preservative agent, an anti-corrosive agent, a deforming agent or their combinations. Preferably, the synthetic carrier fluid is, for example, ethylene glycol (EG), propylene glycol (PG), polyalkylene glycol (PAG), polyethylene glycol (PEG), diethylene glycol (DEG), triethylene glycol (TEG) or their combinations.

In accordance with the present invention, the silicon substrate is a single-crystal silicon substrate, a polycrystalline silicon substrate, or an amorphous silicon substrate. The silicon substrate may be, for example, but not limited to, silicon rod, silicon ingot or silicon brick. The silicon substrate may be further doped with at least one element selected from the group consisting of: boron, phosphorus, arsenic, antimony, aluminum, germanium, and indium. Preferably, an amount of the at least one element relative to the amount of the silicon substrate ranges from 0.0001 to 0.1 percentage by weight (wt %). Preferably, an amount of the at least one element relative to the amount of the silicon substrate ranges from 10¹³ to 10¹⁵ atoms/cm³.

Preferably, the abrasives of the cutting slurry have particle sizes ranging from 2 micrometers to 50 micrometers, and a weight ratio of a total amount of the abrasives to the amount of the silicon substrate ranging from 0.05 to 2.00. Preferably, a diameter of the cutting wire ranges from 80 micrometers to 500 micrometers and more preferably, ranges from 80 micrometers to 200 micrometers. As a result, a fine silicon-containing composition applicable for a lithium-ion battery is produced by using abrasives with preferable particle sizes and a cutting wire with a preferable diameter.

Preferably, the silicon-containing composition has particle sizes ranging from 5 nanometers to 15 micrometers. Said particles sizes of the silicon-containing composition are directed to particle sizes of primary particles before aggregation, and also to particle sizes of secondary particles after aggregation.

Before the sorting and removing step, the particle sizes of the silicon granules and the abrasive granules in the mixing slurry ranges from 5 nanometers to 50 micrometers when the silicon substrate is sliced with a cutting slurry containing abrasive particles ranging from 1 to 50 micrometers.

Preferably, the solid-liquid separation includes centrifuge separation, filter-pressing separation, sedimentation, membrane filtration, or decantation separation.

Preferably, the method comprises removing iron, nickel or their combinations from the solid mixture by magnetic separation to improve the purity of the silicon-containing composition.

Preferably, the method also comprises washing the solid mixture with at least one acidic solution, such as sulfuric acid, hydrochloric acid or nitric acid, to remove the cutting wire granules and oxides thereof from the solid mixture. Herein, the material of the cutting wire granules capable of dissolving in the acidic solution and then removed by the aforementioned step is iron, copper, nickel or their combinations.

In accordance with the present invention, said two steps for removing the cutting wire granules from the solid mixture can be independently performed or in corporation with each other, and the precedence of the two steps is not particularly limited.

Preferably, the step of sorting the solid mixture by particle size is performed by dry separation, wet separation, or their combinations. Thus, a composition containing silicon granules and abrasives with desired particle sizes and amount ratio is produced.

In accordance with the present invention, the dry separation comprises sieve separation, air separation, pneumatic separation, or their combinations. The pneumatic separation comprises pneumatic separation by positive pressure, pneumatic separation by negative pressure and pneumatic separation by positive/negative pressure.

Preferably, the step of sorting the solid mixture by particle size comprises sorting the solid mixture by air separation at a rotating speed ranging from 1500 rpm to 3600 rpm, so as to produce a silicon-containing composition that includes silicon granules in an amount from 40 to 99 wt % and abrasive granules in an amount from 1 to 60 wt %.

In accordance with the present invention, the wet separation comprises hydraulic cyclone separation, flotation or their combinations. The flotation comprises mechanically stirring floatation, pneumatic floatation, mixed floatation, pneumatic stirring floatation and air releasing floatation.

Preferably, step of sorting the solid mixture by particle size comprises sorting the solid mixture by hydraulic cyclone separation under a working pressure ranging from 0.10 to 1.00 mega Pascal (MPa), so as to produce a silicon-containing composition that includes silicon granules in an amount from 40 to 99 wt % and the abrasive granules in an amount from 1 to 60 wt %.

In accordance with the present invention, the step of sorting the solid mixture by particle size and removing the cutting wire granules from the solid mixture comprises: sorting the solid mixture by particle size to obtain a first refined mixture; and removing the cutting wire granules from the first refined mixture, so as to obtain the silicon-containing composition.

Preferably, the step of removing the cutting wire granules from the first refined mixture to obtain the silicon-containing composition comprises: removing iron, nickel or their combinations from the first refined mixture by magnetic separation first; and then washing the first refined mixture with an acidic solution for removing iron, copper, nickel or their combinations from the first refined mixture to obtain the silicon-containing composition. Or, the step of washing the first refined mixture with an acidic solution for removing iron, copper, nickel or their combinations from the first refined mixture can be performed prior to removing iron, nickel or their combinations from the first refined mixture by magnetic separation.

More preferably, the step of sorting the solid mixture by particle size to obtain the first refined mixture comprises: sorting the solid mixture to obtain a sorted mixture; washing the sorted mixture with an aqueous solution to obtain the first refined mixture. Removing the cutting wire granules from the washed first refined mixture in gas as described above is performed later.

In accordance with the present invention, the step of sorting the solid mixture by particle size and removing the cutting wire granules from the solid mixture comprises: removing the cutting wire granules from the solid mixture to obtain a second refined mixture; and sorting the second refined mixture by particle size to obtain the silicon-containing composition.

Preferably, the step of removing the cutting wire granules from the solid mixture to obtain the second refined mixture comprises: removing iron, nickel or their combinations from the solid mixture by magnetic separation first; and then washing the solid mixture with an acidic solution for removing iron, copper, nickel or their combinations from the solid mixture, so as to obtain the second refined mixture. Or, the step of washing the solid mixture with an acidic solution for removing iron, copper, nickel or their combinations from the solid mixture can be performed prior to removing iron, nickel or their combinations from the solid mixture by magnetic separation.

More preferably, the step of removing the cutting wire granules from the solid mixture to obtain the second refined mixture comprises: removing the cutting wire granules from the solid mixture to obtain a collected mixture; and washing the collected mixture with an aqueous solution to obtain the second refined mixture. Sorting the washed second refined mixture by particle size is performed later.

Preferably, the mixing slurry, the solid mixture, the first refined mixture and/or the second refined mixture are washed with an aqueous solution. More specifically, the mixing slurry is washed with the aqueous solution before separating the mixing slurry into the liquid mixture and the solid mixture, and the solid mixture is washed with the aqueous solution before sorting the solid mixture by particle size and removing the cutting wire granules from the solid mixture. Accordingly, the sorting efficiency can be improved by the washing steps. Said aqueous solution may be pure water, water-containing solution, solution collected from the aforementioned washing steps or their combinations.

In accordance with the present invention, the solid-liquid separation and/or washing steps can effectively remove the carrier fluid, additives and/or suspensions from the mixing slurry to prevent these components from adhering to the surface of silicon granules of the silicon-containing composition, so as to improve the electrical performance and quality of a lithium-ion battery comprising the silicon-containing composition.

In accordance with the present invention, the additive is, for example, sodium hexametaphosphate (Na₆(PO₃)₆) or ethylenediaminetetraacetic acid (EDTA), and the suspension is, for example, triethanolamine, dodecane amine, or sodium dodecyl sulfonic acid.

Preferably, the method comprises drying the silicon-containing composition to obtain a powdered silicon-containing composition. Said drying step also has an effect on removing the mineral oil, synthetic oil, additives and/or suspensions to improve the performance of a lithium-ion battery comprising the silicon-containing composition.

Preferably, the particle sizes of the silicon-containing composition are equal to or less than 15 micrometers, and more preferably, range from about 5 nanometers to about 15 micrometers, and further more preferably, range from about 5 nanometers to about 2 micrometers.

Preferably, the percentage of silicon granules contained in the silicon-containing composition is more than 40%. In accordance with the present invention, the major components of the silicon-containing composition are silicon and the abrasive granules.

The second objective of the present invention is to provide an anode material of a lithium-ion battery, which is applicable for producing a lithium-ion battery without extreme volumetric expansion during charging and discharging.

To achieve the objective, the present invention provides an anode material of a lithium-ion battery, comprising a silicon-containing composition produced by a method as described above and having particle sizes ranging from 5 nanometers to 15 micrometers.

Preferably, the silicon-containing composition comprises a large amount of silicon granules, a trace of cutting wire granules, and a few abrasive granules. Based on a total amount of the silicon-containing composition, a total amount of the cutting wire granules and/or abrasive granules is less than 60 wt %.

Preferably, the abrasive granules of the produced silicon-containing composition are for mitigating extreme volumetric expansion of a silicon-containing composition under heat during the charging and discharging process, and further improving the cycle stability and electrical performance of a lithium-ion battery comprising the silicon-containing composition. An amount of the abrasive granules relative to a total amount of the silicon-containing composition ranges from 10 to 40 wt %.

Preferably, the anode material of the lithium-ion battery further comprises carbonaceous material and a binder. The carbonaceous material may be: conductive graphite, e.g., SFG-6, SFG-15, KS-6, KS-15, all manufactured by TIMCAL Ltd.; conductive carbon black, e.g., TIMREX® Ensaco 350G; vapor grown carbon nanofibers (VGCF); carbon nanotubes (CNTs); Ketjenblack, e.g., Ketjenblack EC300J, Ketjenblack EC600JD, Carbon ECP, Carbon ECP600JD, SUPER-P, all manufactured by Lion Corporation, or their combinations. The binder may be: polyvinylidene difluoride (PVDF), N-methylpyrrolidone (NMP), carboxymethyl cellulose sodium (CMC), styrene-butadiene rubber (SBR), polyimide or their combinations.

The third objective of the present invention is to provide a method of producing an anode electrode of a lithium-ion battery, which can reduce the production cost and further improve the capacity stability and electrical performance during multiple cycles.

To achieve the objective, the present invention provides a method of producing an anode electrode of a lithium-ion battery, comprising the steps of:

preparing a silicon-containing composition produced by the method as described above, the silicon-containing composition having particle sizes ranging from 5 nanometers to 15 micrometers;

mixing the silicon-containing composition with a carbonaceous material to form a slurry; and

coating the slurry on a metal substrate and drying the slurry, so as to produce the anode electrode of the lithium-ion battery.

Preferably, the step of preparing a silicon-containing composition further comprises the steps of: providing a wire sawing tool comprising a cutting wire and a cutting slurry applied to the cutting wire, wherein the cutting slurry includes a carrier fluid and multiple abrasives dispersed in the carrier fluid and having particle sizes ranging from 1 micrometer to 50 micrometers; slicing a silicon substrate with the wire sawing tool to obtain a mixing slurry; separating the mixing slurry into a liquid mixture and a solid mixture by solid-liquid separation, wherein the solid mixture includes silicon granules, abrasive granules and cutting wire granules; and sorting the solid mixture by particle size and removing the cutting wire granules from the solid mixture, so as to obtain the silicon-containing composition.

To sum up, the present invention provides a mass production method, comprising slicing a silicon substrate and undergoing suitable purifications, to maintain a few abrasives remaining in the silicon-containing composition, such that the extreme volumetric expansion of the silicon-containing composition under heat can be overcome, and producing a silicon-containing composition superior to that produced by the conventional methods. Consequently, the method in accordance with the present invention not only can produce a silicon-containing composition by low cost and simplified steps, but also can provide a silicon-containing composition applicable for making a lithium-ion battery with improved cycle stability, electrical performance and quality.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of the method of producing a silicon material of Examples 1-6 in accordance with the present invention;

FIGS. 2A and 2B illustrate a silicon substrate sliced by a wire sawing tool;

FIG. 3A is a scanning electron microscope image of a mixing slurry in Examples 1-6;

FIG. 3B is a particle size distribution graph of a mixing slurry in Examples 1-6;

FIG. 4A is a scanning electron microscope image of a second refined mixture in Examples 1-6 after the solid-liquid separation step and washing step;

FIG. 4B is a particle size distribution graph of a second refined mixture in Examples 1-6 after the solid-liquid separation step and washing step;

FIGS. 5A and 5B are scanning electron microscope images of the powdered silicon-containing composition before aggregation in Example 1;

FIG. 6A is a scanning electron microscope image of the powdered silicon-containing composition after aggregation in Example 1;

FIG. 6B is a particle size distribution graph of the powdered silicon-containing composition after aggregation in Example 1;

FIG. 7 shows the capacity versus voltage of a lithium-ion battery in Example 10 after the first charge and discharge cycle;

FIG. 8 shows the capacity versus cycle numbers of a lithium-ion battery in Example 10 during the 1^{st} to 100^{th} charge/discharge cycles; and

FIG. 9 shows the columbic efficiency versus cycle numbers of a lithium-ion battery in Example 10 during the 1^{st} to 100^{th} charge/discharge cycles.

### DETAILED DESCRIPTION OF THE PREFERRED EMBODIMENTS

Hereinafter, one skilled in the arts can easily realize the advantages and effects of a method of producing a silicon-containing composition and its application in accordance with the present invention from the following examples. Therefore, it should be understood that the descriptions proposed herein are just preferable examples only for the purpose of illustrations, not intended to limit the scope of the invention. Various modifications and variations could be made in order to practice or apply the present invention without departing from the spirit and scope of the invention.

### Examples 1-6

### Producing Silicon-Containing Compositions

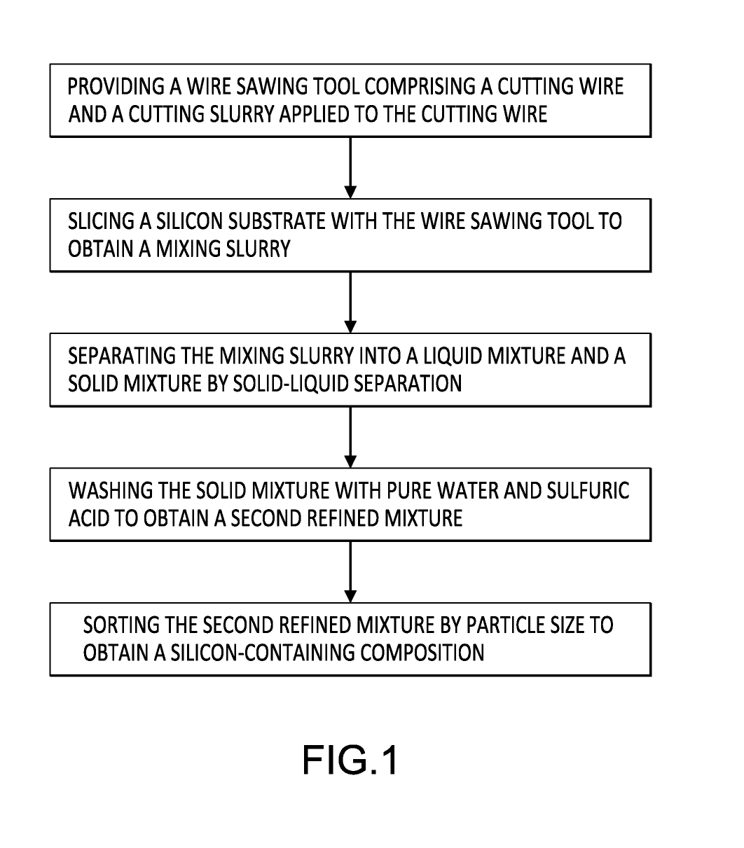

A method of producing a silicon-containing composition was implemented as described in detail incorporating the block diagram as shown in FIG. 1.

First, a silicon substrate and a wire sawing tool for slicing the silicon substrate were provided. In accordance with the present invention, the wire sawing tool comprised a cutting wire and a cutting slurry, which contained a carrier fluid and multiple abrasives dispersed in the carrier fluid. In the present examples, the cutting wire was made of iron and copper, namely a piano wire, and had a diameter of 120 micrometers. The carrier fluid was mainly composed of polyethylene glycol. The abrasives were silicon carbides with particle sizes ranging from 5 micrometers to 40 micrometers. The silicon substrate was a polycrystalline silicon rod doped with 0.01 wt % of boron.

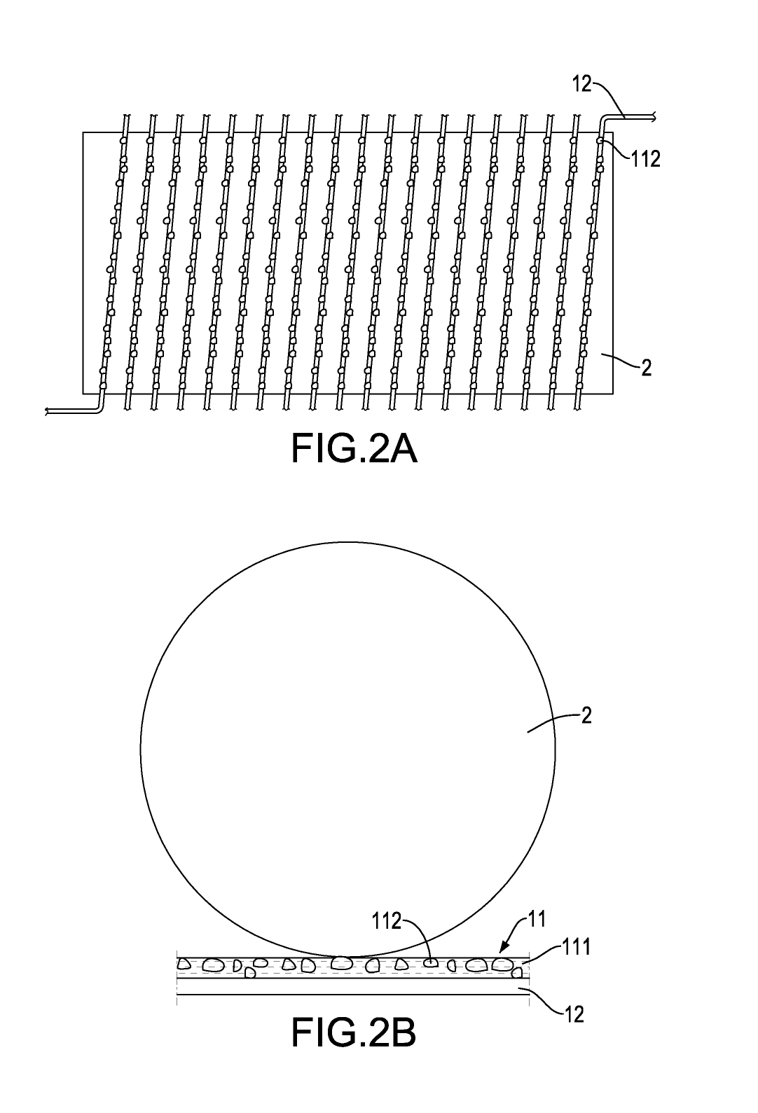

With reference to FIGS. 2A and 2B, the cutting slurry 11 was sprayed onto the cutting wire 12, such that both the carrier fluid 111 and the abrasives 112 were distributed surrounding the cutting wire 12. When the cutting wire 12 was rapidly moved by driving rollers, the cutting slurry 11 was also entered into the cutting area and the abrasives 112 contained in the cutting slurry 11 were grinded the silicon substrate 2 to obtain a mixing slurry.

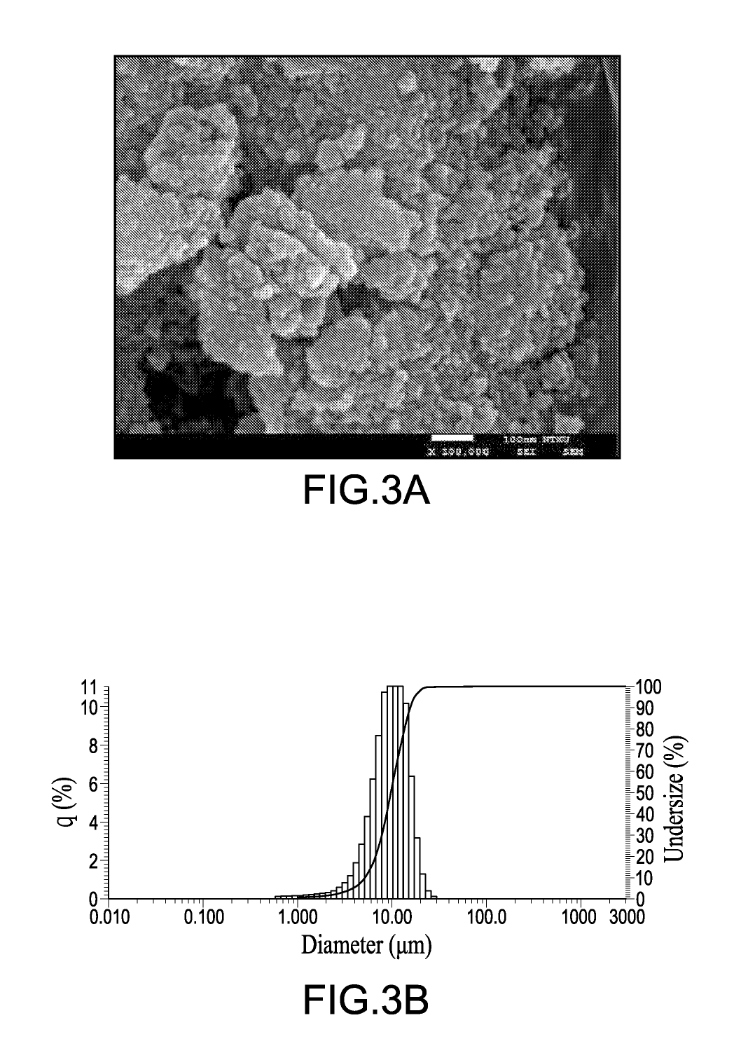

In the aforementioned step, the mixing slurry contained propylene glycol (carrier fluid) and mixed powders, and the mixed powders mainly comprised silicon granules from silicon substrate. Based on a total weight of the solids contained in the mixing slurry, the mixing slurry included 40 wt % of silicon carbide powders and 3 wt % of iron powders. The particle sizes of the mixing slurry were further measured by a particle size distribution analyzer. According to the results, the mixing slurry had primary particle sizes ranging from 5 nanometers to 30 micrometers before aggregation as shown in FIG. 3A and secondary particle sizes ranging from 0.5 micrometers to 30 micrometers after aggregation.

Subsequently, a liquid mixture and a solid mixture were isolated from the mixing slurry by filter-pressing separation. The liquid mixture contained propylene glycol and other additives and suspensions, and the solid mixture contained silicon granules, silicon carbide granules, iron granules, copper granules or their oxides.

Then, the solid mixture was washed with pure water to remove propylene glycol from the solid mixture and further improve the particle size sorting efficiency in the following steps.

After propylene glycol was removed from the solid mixture, the remaining solid mixture was further washed with sulfuric acid to remove the iron powders, copper powders and other metal oxides and alloy oxides soluble in sulfuric acid. Multiple water-washing steps were optionally performed to remove other undesired impurities, so as to obtain a second refined mixture. Accordingly, the purity of silicon-containing composition in accordance with the present invention can be largely improved by these washing steps, and further avoid the deteriorated electrical quality of the lithium-ion battery owing to the metal impurities.

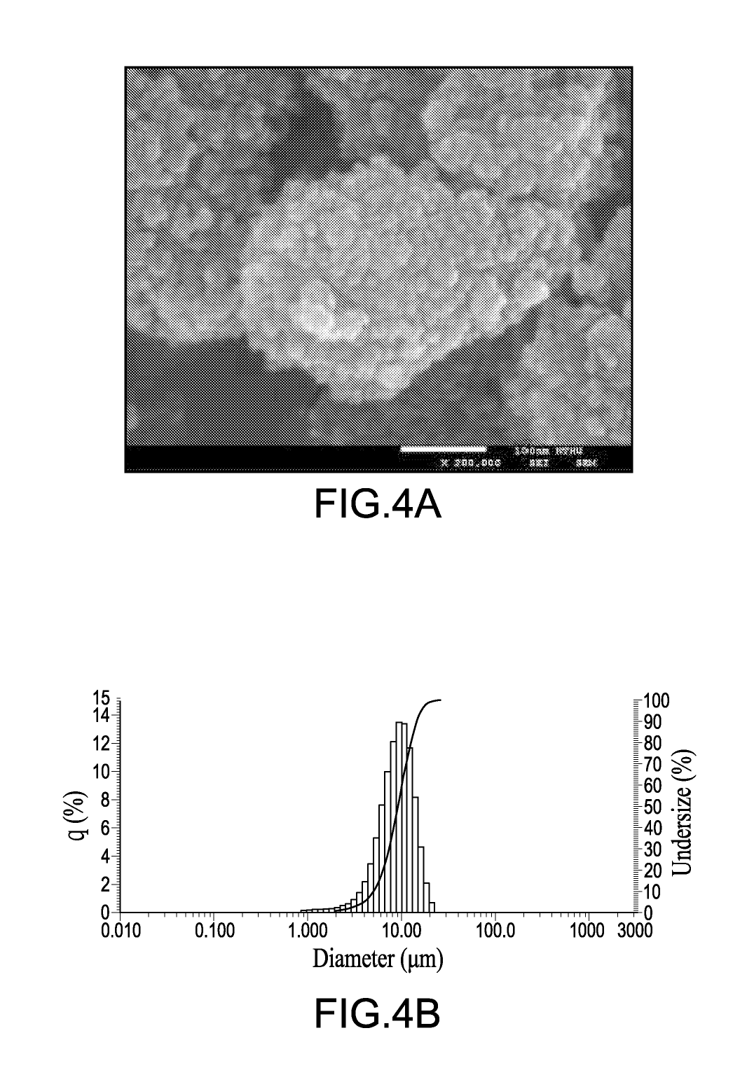

With reference to FIG. 4A, the second refined mixture collected after the solid-liquid separation step and washing steps had primary particle sizes ranging from 5 nanometers to 25 micrometers. With reference to FIG. 4B, the second refined mixture had secondary particle sizes ranging from 0.9 micrometers to 25 micrometers after aggregation. Said second refined mixture contained about 42.73 wt % of silicon powders and about 57.27 wt % of silicon carbide powders.

Next, the second refined mixture was sorted according to particle size by hydraulic cyclone under a working pressure ranging from 0.15 MPa to 0.40 MPa for removing powders larger than 15 micrometers, and then obtaining a silicon-containing composition.

As shown in Table 1, the respective weight ratios of silicon powders and silicon carbide powders were different based on different working pressures of the hydraulic cyclone.

TABLE 1
the working pressure under which the hydraulic cyclone operated and
respective weight ratios of silicon powders and silicon carbides powders
contained in the silicon-containing composition in Examples 1-6.

| | Working pressure | Silicon | Silicon carbide |
|---|---|---|---|
| Example 1 | 0.15 MPa | 53.10 wt % | 46.90 wt % |
| Example 2 | 0.20 MPa | 72.40 wt % | 27.60 wt % |
| Example 3 | 0.25 MPa | 80.00 wt % | 20.00 wt % |
| Example 4 | 0.30 MPa | 87.67 wt % | 12.33 wt % |
| Example 5 | 0.35 MPa | 79.36 wt % | 20.64 wt % |
| Example 6 | 0.40 MPa | 78.38 wt % | 21.62 wt % |

Finally, the silicon-containing composition was further dried at 120° C. to obtain a powdered silicon-containing composition.

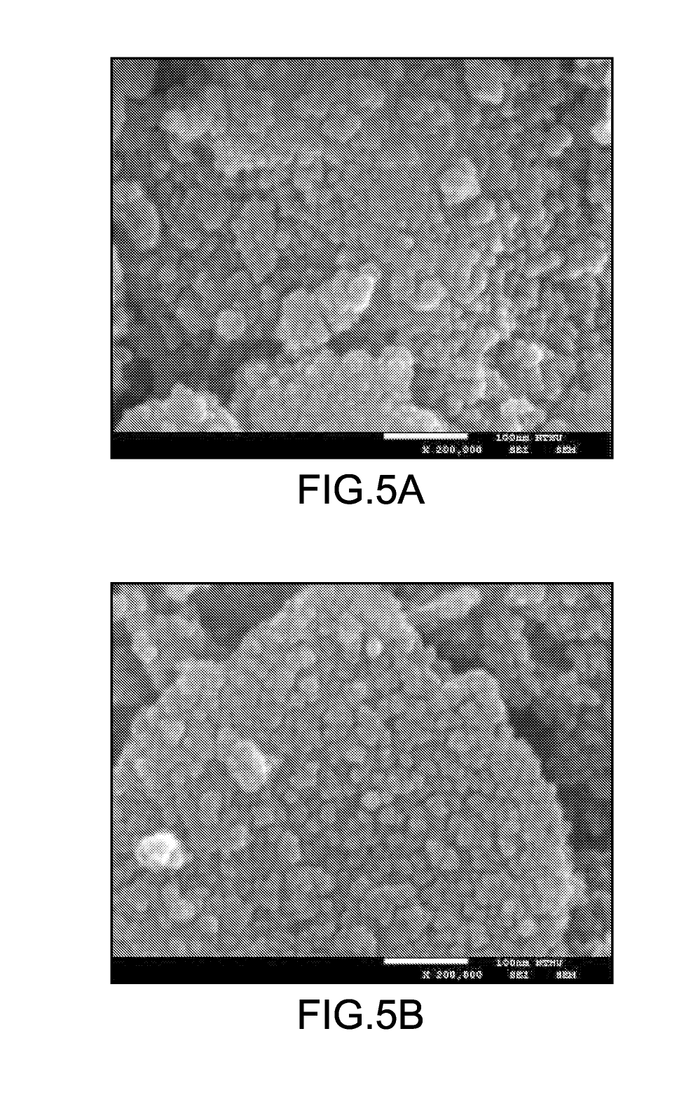

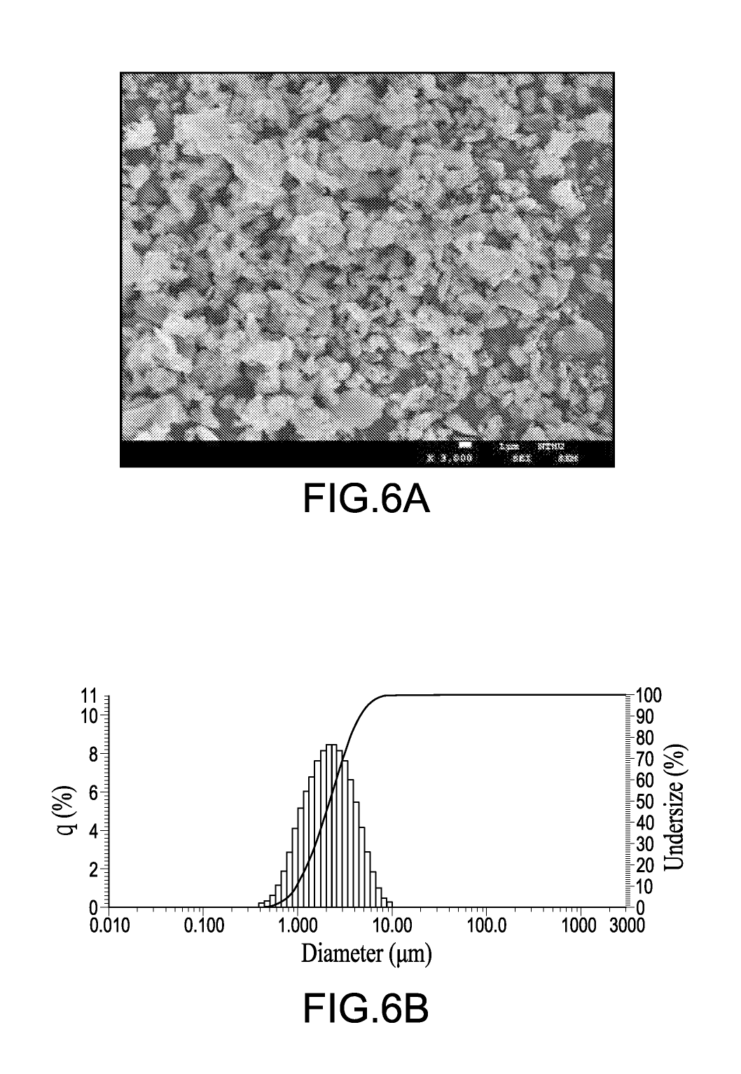

With reference to FIGS. 5A and 5B, the powdered silicon-containing composition does have nano-scale particle sizes about 5 nanometers to 10 nanometers. With reference to FIGS. 6A and 6B, the scanning electron microscope image and particle size distribution graph show that the powdered silicon-containing composition has secondary particle sizes ranging from 0.4 micrometers to 10 micrometers after aggregation.

The powdered silicon-containing composition was further analyzed by optical emission spectral analysis with inductively coupled plasma spectroscopy, ICP-OES spectroscopy. It demonstrated that the iron content in the powdered silicon-containing composition was reduced to less than 50 ppm.

### Examples 7-9

### Producing Silicon-Containing Compositions

In the present example, a mixing slurry was also obtained by the steps performed as Examples 1 to 6. The abrasives used in Examples 7 to 9 were silicon carbides having particle sizes ranging from 5 micrometers to 30 micrometers, and the cutting wire also had a diameter of 120 micrometers.

Subsequently, the mixing slurry was also treated by filter-pressing separation and separated into a liquid mixture and a solid mixture. Wherein, the solid mixture contained about 42.50 wt % of silicon powders and about 57.50 wt % of silicon carbide powders.

Next, the solid mixture was sorted according to particle size by air separation to obtain a first refined mixture. The weight ratio of silicon powders and silicon carbide powders in the first refined mixture depending on the rotating speed were listed in Table 2.

TABLE 2
the rotating speed of air separation and respective weight ratios of
silicon powders and silicon carbides powders contained in the first
refined mixtures in Examples 7-9

| | Rotating speed | Silicon | Silicon carbide |
|---|---|---|---|
| Example 7 | 2880 rpm | 85.00 wt % | 15.00 wt % |
| Example 8 | 2700 rpm | 72.50 wt % | 27.50 wt % |
| Example 9 | 2520 rpm | 55.10 wt % | 44.90 wt % |

Then, the first refined mixture was washed with water to remove propylene glycol from the first refined mixture.

After the carrier fluid was removed, the first refined mixture was washed with sulfuric acid to remove iron powders, copper powders and other metal oxides and alloy oxides, and further washed with water to remove other undesired impurities, so as to produce the silicon-containing composition. In the present example, the silicon-containing composition had particle sizes ranging from 5 nanometers to 15 micrometers.

According to ICP-OES spectroscopy, the iron content in the powdered silicon-containing composition was reduced to less than 50 ppm. It demonstrated that the method can effectively remove undesired impurities, and thereby obtain a silicon-containing composition applicable for a lithium-ion battery.

Based on the results of Examples 1 to 9, the method in accordance with the present invention not only produces a large amount of silicon-containing composition but also effectively removes the undesired impurities to obtain micro-scale, or even nano-scale, silicon-containing composition having a few inactive components, and thereby the silicon-containing composition is a suitable material for a lithium-ion battery.

### Example 10

### Producing a Lithium-Ion Battery Comprising a Silicon-Containing Composition

0.8 grams of powdered silicon-containing composition, which is produced by the method of Example 1, was mixed with 0.2 grams of carbonaceous material (Super-P) to form a slurry for an anode electrode of a lithium-ion battery.

Next, the slurry was spin coated onto a copper foil and then dried, thus an anode electrode of a lithium-ion battery was produced. A lithium foil was provided as a reference electrode, also called relative negative electrode, and the reference electrode could be optionally coated with the positive electrode active material, such as LiCoO₂.

Subsequently, the produced anode electrode was disposed opposite to the reference electrode. A separator membrane was placed between the anode electrode and the reference electrode, and the anode electrode, the reference electrode, and the separator were impregnated in an electrolyte with 1M of ethylene carbonate/diethyl carbonate electrolyte with LiPF₆, to produce a lithium-ion battery.

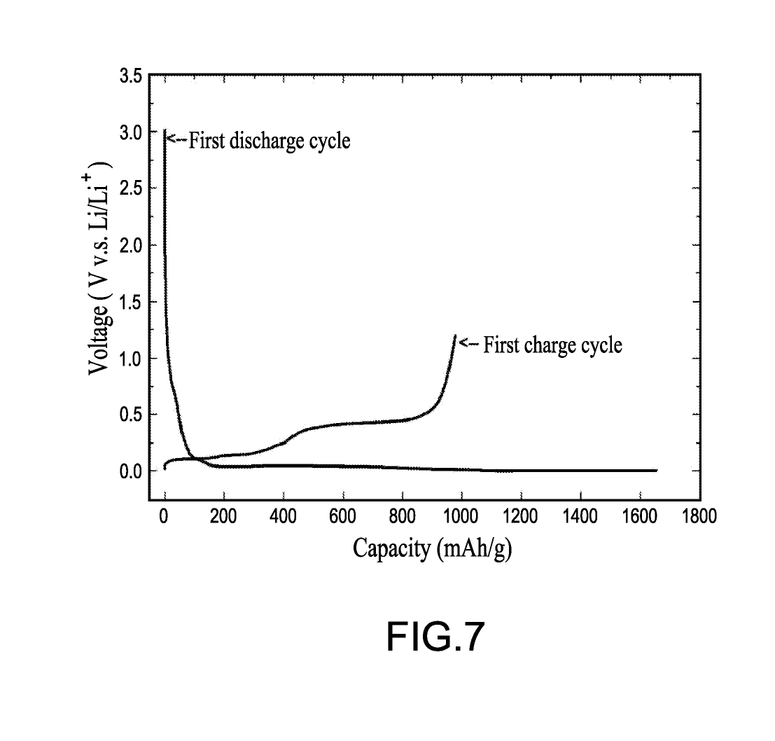

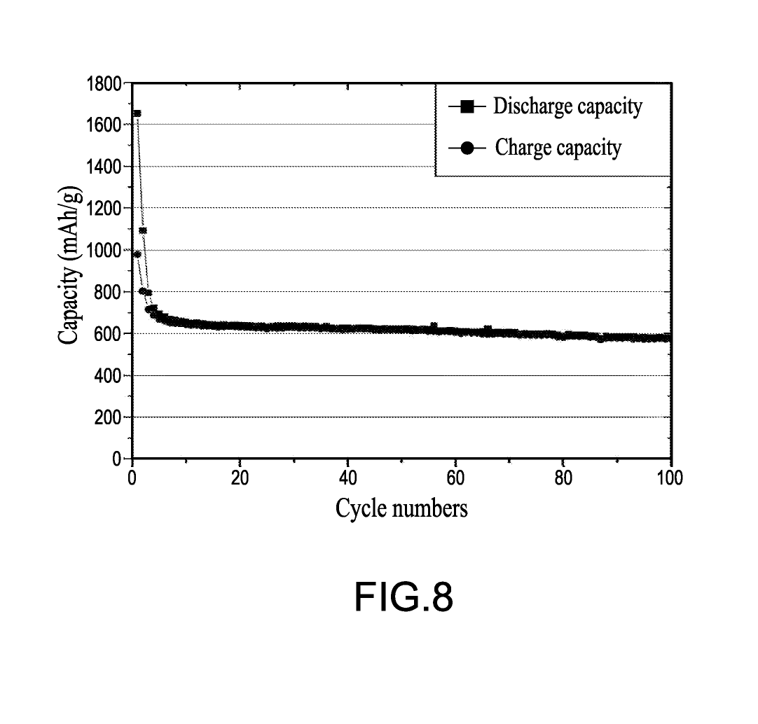

The produced lithium-ion battery was tested by a channel charge/discharge tester at a charge/discharge rate of 0.2 C and a cutoff voltage from 0V to 1.5V. With reference to FIG. 7, the lithium-ion battery had a discharge capacity about 1652 mAh/g on a first discharge and a charge capacity about 976 mAh/g on a first charge. The results proved that the silicon-containing composition produced by the method in accordance with the present invention is suitable as a main component of an anode material in a lithium-ion battery and provides the lithium-ion battery with required charge and discharge ability. With reference to FIG. 8. the lithium-ion battery of the present invention was further repeatedly tested for 100 charge/discharge cycles at a charge/discharge rate of 0.2 C. The result demonstrated that the lithium-ion battery still had a capacity about 574 mAh/g and maintained its stability after 100 cycles.

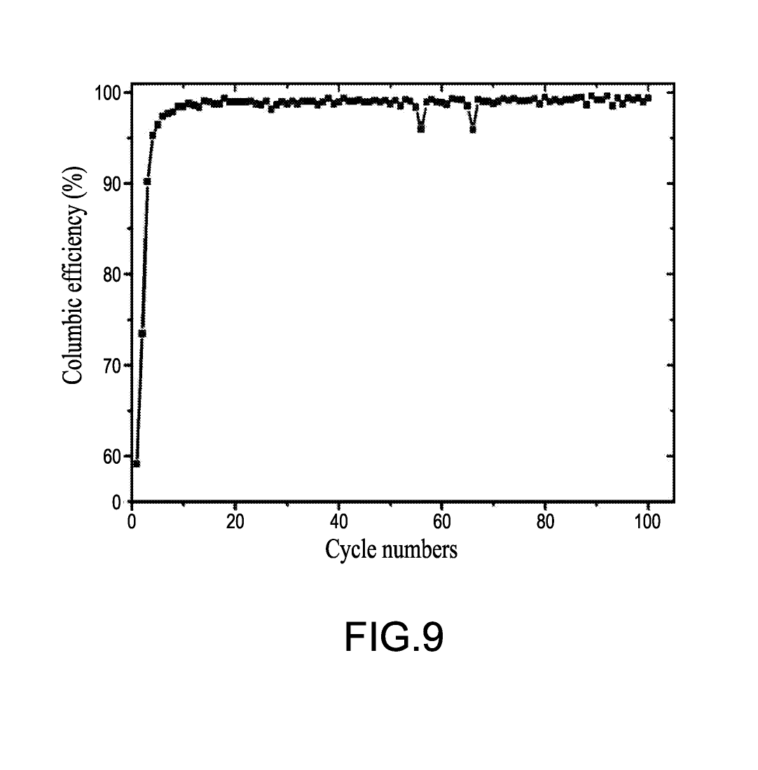

Furthermore, FIG. 9 showed that the lithium-ion battery of the present invention still had a columbic efficiency approximating 100% after 100 cycles.

Accordingly, the present invention successfully provides a mass production method of silicon-containing composition for a lithium-ion battery to reduce its production cost and volumetric expansion problem under heat, thus the cycle stability, electrical performance and quality of the lithium-ion battery are largely enhanced by using the silicon-containing composition of the present invention.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method of producing a silicon-containing composition, comprising the steps of:
providing a wire sawing tool comprising a cutting wire and a cutting slurry applied to the cutting wire, wherein the cutting slurry contains a carrier fluid and multiple abrasives dispersed in the carrier fluid and having particle sizes ranging from 1 micrometer to 50 micrometers;
slicing a silicon substrate with the wire sawing tool to obtain a mixing slurry;
separating the mixing slurry into a liquid mixture and a solid mixture by solid-liquid separation, the solid mixture mixed with silicon granules, abrasive granules and cutting wire granules; and
sorting the solid mixture by particle size and removing the cutting wire granules from the solid mixture, so as to obtain the silicon-containing composition.

2. The method as claimed in claim 1, wherein the cutting wire has a diameter ranging from 80 micrometers to 500 micrometers.

3. The method as claimed in claim 2, wherein the silicon-containing composition has particle sizes ranging from 5 nanometers to 15 micrometers.

4. The method as claimed in claim 1, wherein the carrier fluid of the cutting slurry comprises non-aqueous carrier fluid, aqueous carrier fluid or synthetic carrier fluid.

5. The method as claimed in claim 4, wherein the carrier fluid of the cutting slurry comprises mineral oil.

6. The method as claimed in claim 4, wherein the carrier fluid of the cutting slurry comprises ethylene glycol (EG), propylene glycol (PG), polyalkylene glycol (PAG), polyethylene glycol (PEG), diethylene glycol (DEG), thiethylene glycol (TEG) or their combinations.

7. The method as claimed in claim 1, wherein a material of the abrasive granules is selected from the group consisting of: diamond, diamond-like carbon, silicon carbide, boron nitride, boron carbide, aluminum nitride, zirconium dioxide and their combinations.

8. The method as claimed in claim 1, wherein the solid-liquid separation includes centrifuge separation, filter-pressing separation, sedimentation, membrane filtration, or decantation separation.

9. The method as claimed in claim 1, wherein the method comprises washing the mixing slurry with an aqueous solution before the step of separating the mixing slurry into the liquid mixture and the solid mixture.

10. The method as claimed in claim 1, wherein the method comprises washing the solid mixture with an aqueous solution before the step of sorting the solid mixture by particle size and removing the cutting wire granules from the solid mixture.

11. The method as claimed in claim 1, wherein the method comprises washing the solid mixture with an acidic solution for removing the cutting wire granules from the solid mixture, and the cutting wire granules are made of iron, copper, nickel, or their combinations.

12. The method as claimed in claim 11, wherein the acidic solution comprises sulfuric acid, hydrochloric acid, nitric acid, or their combinations.

13. The method as claimed in claim 1, wherein the method comprises removing the cutting wire granules from the solid mixture by magnetic separation, and the cutting wire granules are made of iron, nickel, or their combinations.

14. The method as claimed in claim 1, wherein the step of sorting the solid mixture by particle size comprises sorting the solid mixture by particle size with dry separation or wet separation.

15. The method as claimed in claim 14, wherein the dry separation includes sieve separation, air separation, pneumatic separation, or their combinations.

16. The method as claimed in claim 15, wherein the step of sorting the solid mixture by particle size comprises sorting the solid mixture by air separation at a rotating speed ranging from 1500 rpm to 3600 rpm.

17. The method as claimed in claim 16, wherein the silicon-containing composition includes the silicon granules in an amount from 40 to 99 wt % and the abrasive granules in an amount from 1 to 60 wt %.

18. The method as claimed in claim 14, wherein the wet separation includes hydraulic cyclone separation, floatation, or their combinations.

19. The method as claimed in claim 18, wherein the step of sorting the solid mixture by particle size comprises sorting the solid mixture by hydraulic cyclone separation under a working pressure ranging from 0.10 to 1.00 MPa.

20. The method as claimed in claim 19, wherein the silicon-containing composition includes the silicon granules in an amount from 40 to 99 wt % and the abrasive granules in an amount from 1 to 60 wt %.

21. The method as claimed in claim 1, wherein the step of sorting the solid mixture by particle size and removing the cutting wire granules from the solid mixture comprises:
sorting the solid mixture by particle size to obtain a first refined mixture; and
removing the cutting wire granules from the first refined mixture, so as to obtain the silicon-containing composition.

22. The method as claimed in claim 21, wherein the cutting wire granules are made of iron, copper, nickel, or their combinations, and the step of removing the cutting wire granules from the first refined mixture to obtain the silicon-containing composition comprises:
removing iron, nickel, or their combinations from the first refined mixture by magnetic separation; and
washing the first refined mixture with an acidic solution for removing iron, copper, nickel, or their combinations from the first refined mixture, so as to obtain the silicon-containing composition.

23. The method as claimed in claim 21, wherein the cutting wire granules are made of iron, copper, nickel, or their combinations, and the step of removing the cutting wire granules from the first refined mixture to obtain the silicon-containing composition comprises:
washing the first refined mixture with an acidic solution for removing iron, copper, nickel, or their combinations from the first refined mixture; and
removing iron, nickel, or their combinations from the first refined mixture by magnetic separation, so as to obtain the silicon-containing composition.

24. The method as claimed in claim 21, wherein the step of sorting the solid mixture by particle size to obtain the first refined mixture comprises:
sorting the solid mixture to obtain a sorted mixture; and
washing the sorted mixture with an aqueous solution to obtain the first refined mixture.

25. The method as claimed in claim 1, wherein the step of sorting the solid mixture by particle size and removing the cutting wire granules from the solid mixture comprises:
removing the cutting wire granules from the solid mixture to obtain a second refined mixture; and
sorting the second refined mixture by particle size to obtain the silicon-containing composition.

26. The method as claimed in claim 25, wherein the cutting wire granules are made of iron, copper, nickel, or their combinations, and the step of removing the cutting wire granules from the solid mixture to obtain the second refined mixture comprises:
removing iron, nickel, or their combinations from the solid mixture by magnetic separation; and
washing the solid mixture with an acidic solution for removing iron, copper, nickel, or their combinations from the solid mixture, so as to obtain the second refined mixture.

27. The method as claimed in claim 25, wherein the cutting wire granules are made of iron, copper, nickel, or their combinations, and the step of removing the cutting wire granules from the solid mixture to obtain the second refined mixture comprises:
washing the solid mixture with an acidic solution for removing iron, copper, nickel, or their combinations from the solid mixture; and
removing iron, nickel, or their combinations from the solid mixture by magnetic separation, so as to obtain the second refined mixture.

28. The method as claimed in claim 25, wherein the step of removing the cutting wire granules from the solid mixture to obtain the second refined mixture comprises:
removing the cutting wire granules from the solid mixture to obtain a collected mixture; and
washing the collected mixture with an aqueous solution to obtain the second refined mixture.

29. The method as claimed in claim 1, wherein the method comprises drying the silicon-containing composition to obtain a powdered silicon-containing composition.

30. The method as claimed in claim 29, wherein the powdered silicon-containing composition has particle sizes ranging from 5 nanometers to 15 micrometers.

31. An anode material of a lithium-ion battery, comprising a silicon-containing composition produced by the method as claimed in claim 1, the silicon-containing composition having particle sizes ranging from 5 nanometers to 15 micrometers.

32. The anode material of the lithium-ion battery as claimed in claim 31, wherein the silicon-containing composition includes silicon granules in an amount from 40 to 99 wt % and abrasive granules in an amount from 1 to 60 wt %.

33. The anode material of the lithium-ion battery as claimed in claim 31, wherein the particle sizes of the silicon-containing composition range from 5 nanometers to 2 micrometers.

34. A method of producing an anode electrode of a lithium-ion battery, comprising the steps of:
preparing a silicon-containing composition produced by the method as claimed in claim 1, the silicon-containing composition having particle sizes ranging from 5 nanometers to 15 micrometers;
mixing the silicon-containing composition with a carbonaceous material to form a slurry; and
coating the slurry on a metal substrate and drying the slurry, so as to produce the anode electrode of the lithium-ion battery.

35. The method as claimed in claim 34, wherein the step of preparing the silicon-containing composition comprises:
providing a wire sawing tool comprising a cutting wire and a cutting slurry applied to the cutting wire, wherein the cutting slurry includes a carrier fluid and multiple abrasives dispersed in the carrier fluid and having particle sizes ranging from 1 micrometer to 50 micrometers;
slicing a silicon substrate with the wire sawing tool to obtain a mixing slurry;
separating the mixing slurry into a liquid mixture and a solid mixture by solid-liquid separation, the solid mixture including silicon granules, abrasive granules, and cutting wire granules; and
sorting the solid mixture by particle size and removing the cutting wire granules from the solid mixture, so as to obtain the silicon-containing composition.
